(19) United States
(12) Patent Application Publication
(10) Pub. No.: US 2022/0136404 A1
(43) Pub. Date: May 5, 2022

(54) GAS TURBINE MASS DIFFERENTIAL DETERMINATION SYSTEM AND METHOD

(71) Applicant: General Electric Company, Schenectady, NY (US)

(72) Inventors: Kiran Vangari, Abu Dhabi Emirate (AE); Lucas Christopher Hunt, Marietta, GA (US); Benjamin Yoo, Chamblee, GA (US); Utkarsha Sunil Barate, Bengaluru (IN)

(21) Appl. No.: 17/084,034

(22) Filed: Oct. 29, 2020

(51) Int. Cl. F01D 21/00

(52) U.S. Cl. CPC F01D 21/003; F05D 2270/303; F05D 2240/60; F05D 2260/80

(57) ABSTRACT

A method for determining mass differential in a hot gas path component of a gas turbine includes monitoring operational conditions of the gas turbine; determining whether changes in a gas turbine wheelspace temperature has occurred; determining whether a wheelspace temperature has changed by comparing the wheelspace temperature to at least one of a compressor inlet temperature and a compressor discharge temperature indicates a change in temperature; in response to determining the wheelspace temperature indicates a change in temperature has occurred; determining whether at least one of the following exists: a gas turbine exhaust temperature indicates a simultaneous change with the temperature change between wheelspace temperature compared to the at least one of the compressor inlet temperature and the compressor discharge temperature, and a gas turbine vibrational change. In response to at least one of the simultaneous change and the vibrational change existing, indicating a mass deviation in the hot gas path component of the gas turbine.

### BACKGROUND

The disclosure relates generally to systems and methods for determination of mass changes or differentials in gas turbines. In particular, the disclosure relates to systems and methods for determination of mass changes or differentials in hot gas path components of a gas turbine.

Detection of mass changes in a gas turbine components, including but not limited to hot gas path components of a gas turbine, when the changes are minor and being alerted is useful to avoid substantial mass changes associated with missile events, blade failure and liberation, and fatigue. The realization and detection of minor mass differentials during monitoring of a gas turbine can alert an operator of the gas turbine of a possibility of an impending failure. Thus, monitoring mass differentials associated with, for example, erosion, cracking, spalling, fouling, build-up of emission particulates, and other such causes, may reduce further damage to gas turbine components.

### BRIEF DESCRIPTION

A first aspect of the disclosure provides a method for determining mass differential in a hot gas path component of a gas turbine includes monitoring operational conditions of the gas turbine; determining whether changes in a gas turbine wheelspace temperature has occurred; determining whether a wheelspace temperature has changed by comparing the wheelspace temperature to at least one of a compressor inlet temperature and a compressor discharge temperature indicates a change in temperature; in response to determining the wheelspace temperature indicates a change in temperature has occurred; determining whether at least one of the following exists: a gas turbine exhaust temperature indicates a simultaneous change with the temperature change between wheelspace temperature compared to the at least one of the compressor inlet temperature and the compressor discharge temperature, and a gas turbine vibrational change. In response to at least one of the simultaneous change and the vibrational change existing, indicating a mass deviation in the hot gas path component of the gas turbine.

A second aspect of the disclosure provides a gas turbine control for a gas turbine, the control monitoring and determining mass differentials in a hot gas path component of a gas turbine. The control comprises at least one sensor monitoring gas turbine operational conditions, the at least one sensor monitoring one or more of shaft speed, gas turbine load, wheelspace temperature, vibration, gas turbine exhaust temperature, compressor inlet temperature, and compressor discharge temperature; and a non-transitory computer-readable medium comprising computer-executable instructions for operating a gas turbine, the instructions including instruction for: monitoring parameters and operational conditions of the gas turbine; determining whether changes in gas turbine wheelspace temperatures have occurred; determining whether wheelspace temperature indicates a change in temperature; determining whether wheelspace temperature indicates a change in temperature has occurred; then determining whether at least one of: gas turbine exhaust temperatures indicate a simultaneous change with the temperature change between wheelspace temperature compared to the at least one of compressor inlet temperature and compressor discharge temperature; and a gas turbine vibrational change. In response to at least one of the simultaneous change and the vibrational change existing, indicating a mass deviation in the hot gas path component of the gas turbine.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 is a schematic representation of an illustrative combustion gas turbine engine as embodied by the disclosure in which embodiments of the present application may be used;

FIG. 2 is a sectional view of the compressor in the combustion gas turbine engine of FIG. 1 as embodied by the disclosure;

FIG. 3 is a sectional view of the gas turbine in the combustion gas turbine engine of FIG. 1 as embodied by the disclosure;

FIG. 4 illustrates a flow chart according to one aspect of the process, as embodied by the disclosure; and

FIG. 5 illustrates an illustrative control and related computer for determining mass differentials in a hot gas path component of a gas turbine includes monitoring parameters and operational conditions of the gas turbine.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION

As an initial matter, in order to clearly describe the current technology, it will become necessary to select certain terminology when referring to and describing relevant machine components within a gas turbine, and in particular in a hot gas path portion of a gas turbine. To the extent possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

In addition, several descriptive terms may be used regularly herein, and it should prove helpful to define these terms at the onset of this section. These terms and their definitions, unless stated otherwise, are as follows. As used herein, “downstream” and “upstream” are terms that indicate a direction relative to the flow of a fluid, such as the working fluid through the gas turbine engine or, for example, the flow of air through the combustor or coolant through one of the gas turbine's component systems. The term “downstream” corresponds to the direction of flow of the fluid, and the term “upstream” refers to the direction opposite to the flow. The terms “forward” and “aft,” without any further specificity, refer to directions, with “forward” referring to the front or compressor end of the engine, and “aft” referring to the rearward or gas turbine end of the engine.

It is often required to describe parts that are disposed at differing radial positions with regard to a center axis. The term “radial” refers to movement or position perpendicular to an axis. For example, if a first component resides closer to the axis than a second component, it will be stated herein that the first component is “radially inward” or “inboard” of the second component. If, on the other hand, the first component resides further from the axis than the second component, it may be stated herein that the first component is “radially outward” or “outboard” of the second component. The term “axial” refers to movement or position parallel to an axis. Finally, the term “circumferential” refers to movement or position around an axis. It will be appreciated that such terms may be applied in relation to the center axis of the gas turbine.

In addition, several descriptive terms may be used regularly herein, as described below. The terms “first”, “second”, and “third” may be used interchangeably to distinguish one component from another and are not intended to signify location or importance of the individual components.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

Where an element or layer is referred to as being “on,” “engaged to,” “connected to” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

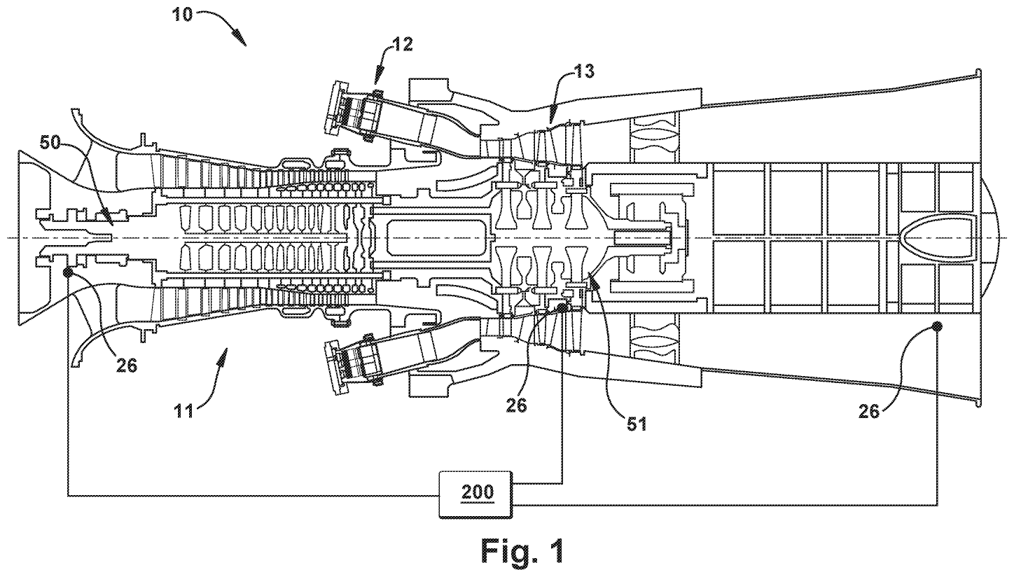

By way of background, referring now to the Figures, FIGS. 1 through 3 show an illustrative combustion gas turbine engine in which embodiments of the present application may be used. It will be understood by those skilled in the art that the present embodiments are not limited to this type of usage. As stated, the present embodiments may be used in combustion gas turbine engines, such as the engines used in power generation and airplanes, steam gas turbine engines, and other type of rotary engines.

FIG. 1 illustrates an illustrative combustion gas turbine engine in which embodiments of the present application may be used. It will be understood by those skilled in the art that the present embodiments are not limited to this type of combustion gas turbine engine usage. As stated, the present embodiments may be used in combustion gas turbine engines, such as, but not limited to, engines used in power generation and airplanes, steam gas turbine engines, and other type of rotary engines. In general, combustion gas turbine engines operate by extracting energy from a pressurized flow of hot gas produced by the combustion of a fuel in a stream of compressed air. As illustrated in FIG. 1, combustion gas turbine engine system 10 may be configured with an axial compressor 11 that is mechanically coupled by a common shaft or rotor to a downstream gas turbine section or combustion gas turbine engine 13 (hereinafter “gas turbine”), and a combustor 12 positioned between compressor 11 and gas turbine 13.

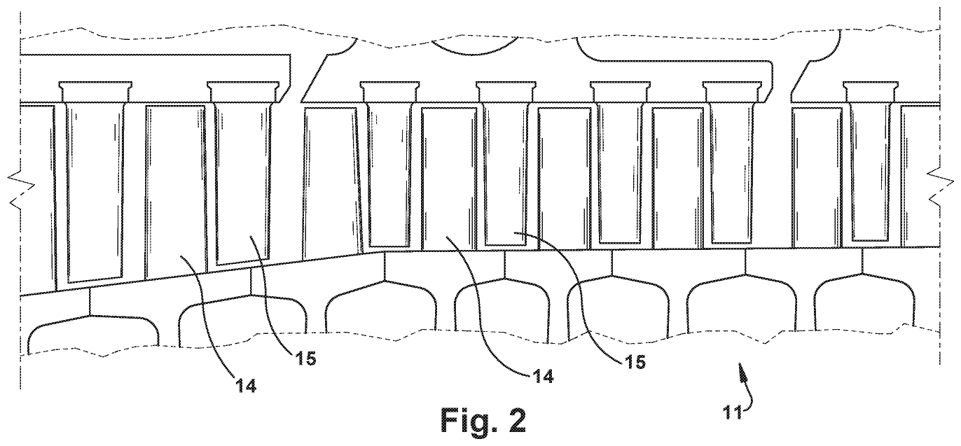

FIG. 2 illustrates a view of an illustrative, non-limiting, multi-staged axial compressor 11 that may be used in gas turbine 13 of FIG. 1. As shown, compressor 11 may include a plurality of stages. Each stage may include a row of compressor rotor blades 14 followed by a row of compressor stator nozzles 15. Thus, a first stage may include a row of compressor rotor blades 14, which rotate about a central shaft, followed by a row of compressor stator nozzles 15, which remain stationary during operation. The compressor stator nozzles 15 generally are circumferentially spaced one from the other and fixed about the axis of rotation. The compressor rotor blades 14 are circumferentially spaced and attached to the shaft. When the shaft rotates during operation, compressor rotor blades 14 rotate with it. Compressor rotor blades 14 are configured such that, when spun about the shaft, they impart kinetic energy to the air or fluid flowing through compressor 11. Compressor 11 may have other stages beyond the stages that are illustrated in FIG. 2. Additional stages may include a plurality of circumferential spaced compressor rotor blades 14 followed by a plurality of circumferentially spaced compressor stator nozzles 15.

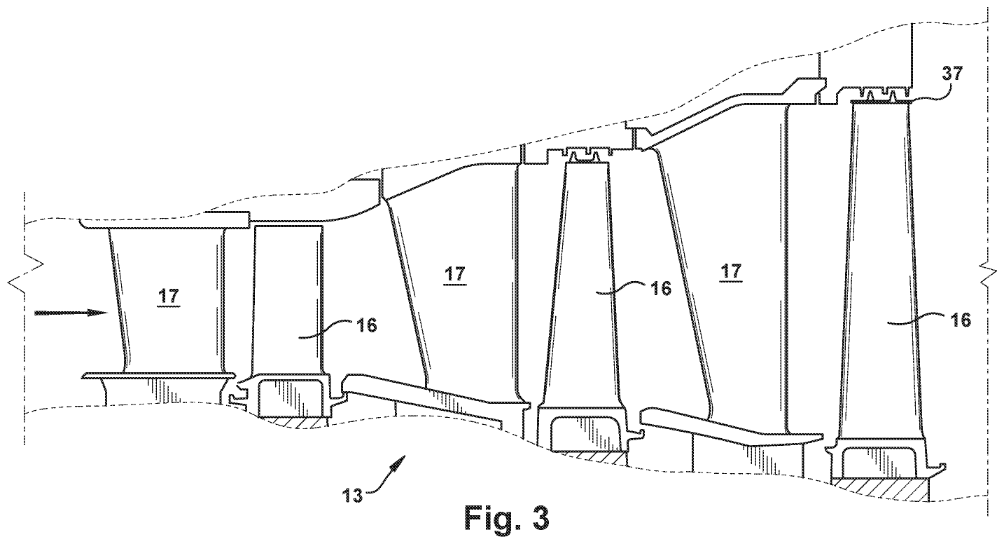

FIG. 3 illustrates a non-limiting, partial view of an illustrative gas turbine section or gas turbine 13 that may be used in the combustion gas turbine engine of FIG. 1. Gas turbine 13 also may include a plurality of stages. Three illustrative gas turbine stages are illustrated, but this is merely illustrative and is non-limiting and not intended to restrict the embodiments in any manner. Accordingly, more or less gas turbine stages may present in gas turbine 13. A first gas turbine stage includes a plurality of gas turbine buckets or gas turbine rotor blades 16 (hereinafter “blades”), which rotate about the shaft during operation, and a plurality of nozzles or gas turbine stator blades 17 (hereinafter “nozzles”), which remain stationary during operation. Nozzles 17 generally are circumferentially spaced one from the other and fixed about the axis of rotation. Gas turbine rotor blades 16 may be mounted on a gas turbine wheel or disc (not shown) for rotation with the gas turbine shaft 50. A second stage of gas turbine 13 also is illustrated. The second gas turbine stage similarly includes a plurality of circumferentially spaced nozzles 17 followed by a plurality of circumferentially spaced gas turbine rotor blades 16, which are also mounted on gas turbine wheel for rotation. A third gas turbine stage also is illustrated, and similarly includes a plurality of nozzles 17 and rotor blades 16. It will be appreciated that gas turbine nozzles 17 and rotor blades 16 lie in the hot gas path of gas turbine 13. The direction of flow of the hot gases through the gas turbine hot gas path is indicated by the arrow. Gas turbine 13 may have other stages beyond the stages that are illustrated in FIG. 3. Each additional gas turbine stage may include a row of gas turbine nozzles 17 followed by a row of gas turbine rotor blades 16.

In a non-limiting description of use, rotation of compressor rotor blades 14 within axial compressor 11 may compress a flow of air. In combustor 12, energy may be released when the compressed air is mixed with a fuel and ignited. The resulting flow of hot gases from combustor 12, which may be referred to as the working fluid, is then directed over gas turbine rotor blades 16, the flow of working fluid inducing the rotation of gas turbine rotor blades 16 and shaft 50. Thereby, energy of the flow of working fluid is transformed into mechanical energy of the rotating blades and, because of the connection between the rotor blades and the shaft, shaft 50 rotates. The mechanical energy of shaft 50 may then be used to drive rotation of compressor rotor blades 14, such that the necessary supply of compressed air is produced, and also, for example, a generator to produce electricity.

The operation of the gas turbine may be monitored by several sensors 26 detecting various operational conditions of the gas turbine, generator, and balance of plant, including those of the gas turbine's ambient environment. FIG. 1 illustrates various positions that sensors 26 may be located to determine various parameters and operational conditions. As embodied by the disclosure, these positions are not intended to limit the embodiments in any manner, and positioning of sensors 26 may be at any location, now known or hereinafter determined, in gas turbine 13 or gas turbine system that will enable parameters and operational conditions to be determined.

As embodied by the disclosure, at least one sensor 26 is positioned on, at, in, or communicating with the wheelspace 51 to determine a wheelspace temperature (WS Temp). In an aspect of the embodiments, multiple sensors 26 can be positioned in the same wheelspace 51. The multiple sensors 26 that may be positioned in the same wheelspace 51 are radially spaced to provide multiple wheelspace temperatures (WS Temp).

Further, WS Temp will be evaluated to determine any mass differential, either an increase or decrease, in hot gas path components. Further, as embodied by the disclosure, other sensors 26 may be provided to determine various parameters and operational conditions of the gas turbine, which also may be evaluated to determine any mass differential, either an increase or decrease, in hot gas path components. These conditions, include but are not limited to, shaft speed (TNH), load (DWATT), shaft vibration, gas turbine exhaust temperature (TTXM), bearing vibration, gas turbine gross power and efficiency changes, and compressor inlet and discharge temperatures (CTIM and CTD, respectively), and any other gas turbine parameters and operational conditions now known or hereinafter determined to be desired for gas turbine operational monitoring.

As embodied by the disclosure, temperature sensors 26 may monitor ambient temperature surrounding gas turbine 13, compressor discharge temperature, gas turbine exhaust gas temperature, and other temperature measurements of the gas stream through gas turbine 13.

Sensors 26 may also comprise flow sensors, speed sensors, rotor (or shaft) vibration, flame detector sensors, valve position sensors, guide vane angle sensors, or the like that sense various parameters pertinent to the operation of gas turbine 13. As used herein, operating conditions refer to items that can be used to define the of gas turbine, such as temperatures, pressures, and flows at defined locations in the gas turbine that can be used to represent a given gas turbine operating condition.

An aspect of the embodiment includes detecting increases or decreases in mass of gas turbine hot gas path section components. As embodied by the disclosure, the detecting may be a decrease due to liberations and/or mass loss events in gas turbine hot gas path section, even if a minor mass loss event. Such minor mass loss events may include liberations of materials from gas turbine hot gas path section components, including but not limited to at least one of nozzles and blades.

Moreover, a further aspect as embodied by the disclosure includes detecting an increase in mass of gas turbine hot gas path section components. In accordance with aspects of the disclosure, an increase in mass of gas turbine hot gas path section components may result from deposits on stationary or rotating gas turbine hot gas path components within the gas turbine hot gas path section, including but not limited to at least one of nozzles and blades.

The term “gas turbine hot gas path section component” as used herein includes, but is not limited to, combustion liners, transition pieces, turbine nozzles and turbine blades, end caps, fuel nozzle assemblies, crossfire tubes, turbine stationary shrouds, and turbine blades (buckets), which are typically are exposed to hot gases. These gas turbine hot gas path section components can be stationary, such as nozzle assemblies and combustion liners) or rotating, such as blades, that may also be cooled by secondary airflow in the gas turbine system.

As embodied by the disclosure, detecting increases or decreases in mass of gas turbine hot gas path section components includes monitoring changes in turbine operational parameters such as wheelspace temperatures, vibration, exhaust temperature, exhaust spread, compressor discharge temperature, and other various operational conditions of the gas turbine. A further aspect of the detecting, as embodied by the disclosure, includes determining the various operational conditions in real time using on-site monitoring (OSM) data, and in turn using the real time operational conditions to determine increases or decreases in mass of gas turbine hot gas path section components.

In accordance with certain aspects of the embodiments, monitoring of changes and deviations of various parameters and operational conditions in real time using on-site monitoring (OSM) data can indicate increases on (deposits) or decreases (liberations/mass loss) of at least one of stationary or rotating gas turbine hot gas path section components. As embodied by the disclosure, wheelspace temperature changes are at least one primary indicator of increases or decreases of mass of at least one of stationary or rotating gas turbine hot gas path section components. As discussed above, at least one sensor 26 is able to determine temperatures, and accordingly temperature changes in the wheelspace.

Depending whether an up or down trend or behavior is observed, wheelspace temperature data can be normalized with a turbine inlet temperature. A normalized wheelspace temperature can be used along with at least one of changes in rotor vibration (typically used only to determine anomalies on rotating gas turbine hot gas path section components), and gas turbine exhaust temperature spread to determine a value that an anomaly in at least one of stationary or rotating gas turbine hot gas path section components has occurred. The anomaly of at least one of stationary or rotating gas turbine hot gas path section components can be a decrease in mass or an increase in mass.

As embodied by the disclosure, the process, described hereinafter, utilizes diagnostics that analyze combinations of parameter changes to detect whether any deviation in mass is indicated. In certain embodiments of the disclosure, deviation in mass may include an increase or decrease in mass of at least one of stationary or rotating gas turbine hot gas path section components. Moreover, the process and diagnostics, as embodied by the disclosure, are effective in determining minor increases or decreases in mass of at least one of stationary or rotating gas turbine hot gas path section component, where the term minor means mass differentials associated with, for example, erosion, cracking, spalling, fouling, build-up of emission particulates.

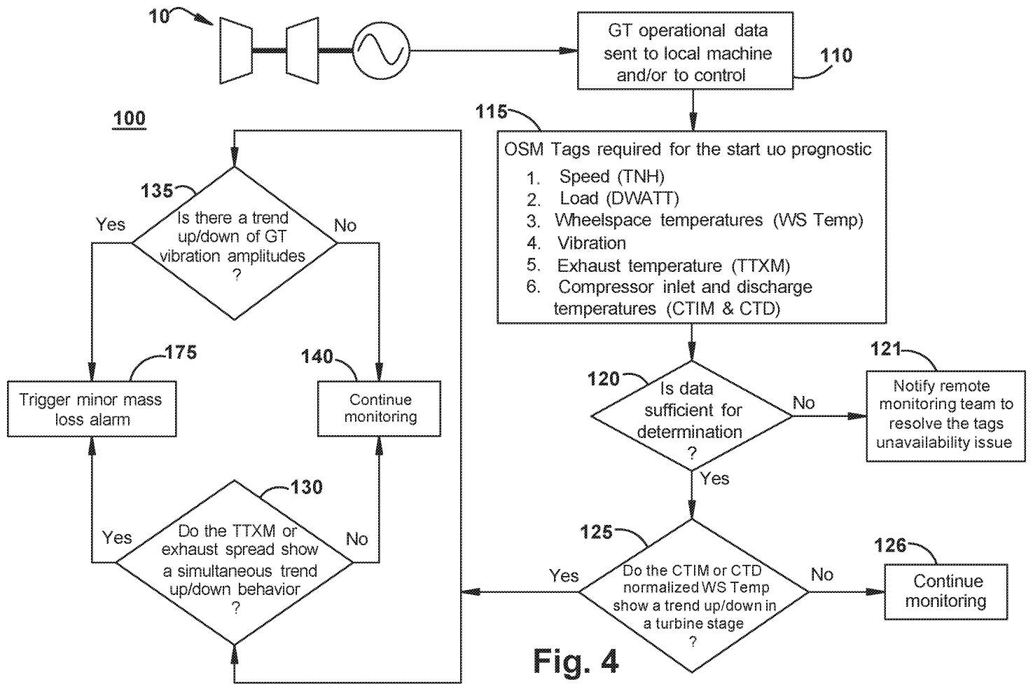

As illustrated in FIG. 4, the process 100 for utilizing diagnostics to analyze combinations of condition changes to detect whether any mass deviation, such as an increase or decrease in mass of at least one of stationary or rotating gas turbine hot gas path section components combustion will now be described. Combustion gas turbine 10 is provided with sensors 26 that can send gas turbine real time parameters and operational conditions to a computer device or control 200 (hereinafter “control”), at step 110. Control 200, as described hereinafter, may include or comprise a computer device, and utilizes diagnostics that analyze combinations of various gas turbine real time parameters and operational condition changes to detect whether any mass deviation, such as an increase or decrease in mass of at least one of stationary or rotating gas turbine hot gas path section components, is indicated.

The monitoring in control 200 is provided in real-time and includes calculations and analytics that can be performed in real-time, dynamically, and automatically. Thus, an operator of control 200 need not have to reprogram algorithm(s) time after time. As used herein, real-time refers to occurring at a substantially short period after a change in inputs affecting the outcome, for example, computational calculations. In the illustrative embodiment, calculations are updated in real-time with a periodicity determined by the scan time and clock speed of control 200.

Process 100 continues with control 200 receiving various gas turbine real time parameters and operational conditions at step 115. These gas turbine real time parameters and operational conditions, include but are not limited to, wheelspace temperature (WS Temp), shaft speed (TNH), load (DWATT), shaft vibration and vibration amplitudes, gas turbine exhaust temperature (TTXM), bearing vibration and vibration amplitudes, gas turbine gross power and efficiency changes, and compressor inlet and discharge temperatures (CTIM & CTD), and any other gas turbine parameters and operational conditions, now known or hereinafter determined to be desired for gas turbine operational monitoring.

Control 200 then determines whether gas turbine real time parameters and operational conditions are sufficient for a determination detecting increases or decreases in mass of gas turbine hot gas path section components at step 120. In response to the gas turbine real time parameters and operational conditions determined not to be sufficient, such as some data not being available or that more data is needed, control 200 generates a notification to provide further, additional, or appropriate gas turbine real time parameters and operational conditions at step 121.

In response to sufficient gas turbine real time parameters and operational conditions being provided, the process 100 proceeds to step 125, where at least one of compressor inlet and discharge temperatures (CTIM & CTD) normalized to wheelspace temperature (WS Temp), and analyzed. These real time parameters and operational conditions are evaluated to determine whether there exists an increasing or decreasing WS Temp trend. With no increasing or decreasing WS Temp trend, monitoring is continued at step 126, as there is no indication of liberations and/or mass loss events in gas turbine hot gas path section, nor deposits on stationary or rotating gas turbine hot gas path components within the gas turbine hot gas path section.

Whether an increasing or decreasing WS Temp trend is determined at step 125, process 100 continues to analyze at least one of gas turbine exhaust temperature (TTXM) or a TTXM difference between monitoring events at step 130 and any changes in vibrational amplitude from real time parameters and operational conditions of gas turbine 13 at step 135. These two steps 130 and 135 can be done in parallel, one at a time with either step first, or in any other fashion that provides control 200 with an indication of changes at the steps 130 and 135.

Depending whether at step 130, as embodied by the disclosure, TTXM or TTXM difference between monitoring events exhibits an increasing or decreasing TTXM or TTXM difference trend, which is simultaneous with an increasing or decreasing WS Temp trend, control 200 generates a mass deviation alarm at step 175. Mass devotion alarm at step 175 indicates either a mass loss or a mass gain in a stationary or rotating gas turbine hot gas path components within the gas turbine hot gas path section.

Depending whether at step 130 there is no increasing or decreasing TTXM or TTXM difference trend simultaneous with an increasing or decreasing WS Temp trend, control 200 has process 100 continue to monitor gas turbine real time parameters and operational conditions at step 140. The continuation of monitoring is because the control 200 does not have an indication of liberations and/or mass loss events in gas turbine hot gas path section components, nor deposits on gas turbine hot gas path components within gas turbine hot gas path section.

Depending whether an increasing or decreasing WS Temp trend is determined at step 125, process 100 can also continue to step 135. At step 135, control 200 analyzes monitored gas turbine real time parameters and operational conditions to determine whether there are any simultaneous, with an increasing or decreasing WS Temp, changes in gas turbine vibration amplitude. Changes in vibration amplitude include but are not limited to vibration from bearing, shaft, or any other component's vibration from gas turbine that sensor 26 may indicate. Depending whether process 100 indicates a vibrational difference between monitoring steps, that is simultaneous with an increasing or decreasing WS Temp trend, control 200 generates a mass devotion alarm at step 175. Mass devotion alarm at step 175 indicates either a mass loss or a mass gain in a stationary or rotating gas turbine hot gas path components within the gas turbine hot gas path section.

Similar to above, and as embodied by the disclosure, depending whether at step 135 there is no increasing or decreasing vibrational trend simultaneous with an increasing or decreasing WS Temp trend, control 200 has process 100 continue to monitor gas turbine real time parameters and operational conditions at step 140. As above, this continued monitoring is an indication of no liberations and/or mass loss events in gas turbine hot gas path section, nor deposits on gas turbine hot gas path components within gas turbine hot gas path section.

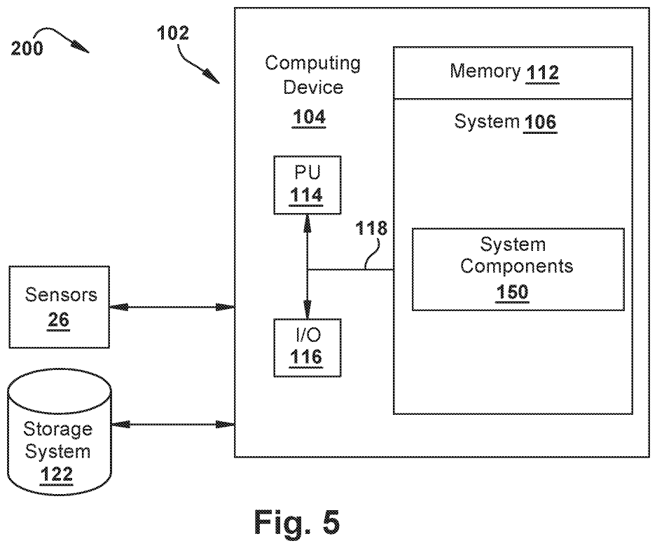

With reference to FIG. 5, as will be appreciated by one skilled in the art, the methodology and system, as embodied by the disclosure, can be provided as a system and/or method utilizing control 200. As embodied by the disclosure, control 200 may include a computer program product. Accordingly, control 200 may take the form of an entirely hardware embodiment, an entirely software embodiment (including firmware, resident software, micro-code, etc.), or an embodiment combining software and hardware. Furthermore, control 200 may include a computer program product embodied in any tangible medium of expression having computer-usable program code embodied in the medium to perform the process, as embodied by the disclosure.

As embodied by the disclosure, process 100 is described below with reference to flowchart (FIG. 4), illustrations, and/or block diagrams. It will be understood that each block of the flowchart illustrations and/or block diagrams, and combinations of blocks in the flowchart illustrations and/or block diagrams, can be implemented by computer program instructions, and control 200 can be embodied in such computer or computer program instructions. These computer program instructions may be provided in a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

To this extent, control 200 may include or be included as a computer infrastructure 102 that can perform the various process steps described herein for determining mass differential in a hot gas path component of a gas turbine. In particular, computer infrastructure 102 is shown including a computing device 104 that comprises a system 106, which enables computing device 104 and control 200 to determine mass differential in a hot gas path component of a gas turbine by performing the process steps of the disclosure.

Control 200, in FIG. 5, is illustrated shown including a memory 112, a processor (PU) 114, an input/output (I/O) interface 116, and a bus 118. Further, computing device 104 is shown in communication with sensors 26. As is known in the art, in general, processor 114 executes computer program code, such as system 106, which may be stored in memory 112 and/or storage system 122. While executing computer program code, processor 114 can read and/or write data, such as, but not limited to operational conditions of the gas turbine, to/from memory 112, storage system 122, and/or I/O interface 116. Bus 118 provides a communications link between each of the components in computing device 104. I/O device 118 can comprise any device that enables a user to interact with computing device 104 or any device that enables computing device 104 to communicate with one or more other computing devices. Input/output devices (including but not limited to keyboards, displays, pointing devices, etc.) can be coupled to the system either directly or through intervening I/O controllers.

In any event, computing device 104 can comprise any general purpose computing article of manufacture capable of executing computer program code installed by a user (e.g., a personal computer, server, handheld device, etc.). However, it is understood that computing device 104 and system 106 are only representative of various possible equivalent computing devices that may perform the various process steps of the disclosure. To this extent, in other embodiments, computing device 104 can comprise any specific purpose-computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, computer infrastructure 102 is only illustrative of various types of computer infrastructures for implementing the disclosure. For example, in one embodiment, computer infrastructure 102 comprises two or more computing devices (e.g., a server cluster) that communicate over any type of wired and/or wireless communications link, such as a network, a shared memory, or the like, to perform the various process steps of the disclosure. When the communications link comprises a network, the network can comprise any combination of one or more types of networks (e.g., the Internet, a wide area network, a local area network, a virtual private network, etc.). Network adapters may also be coupled to the system to enable the data processing system to become coupled to other data processing systems or remote printers or storage devices through intervening private or public networks. Modems, cable modem and Ethernet cards are just a few of the currently available types of network adapters. Regardless, communications between the computing devices may utilize any combination of various types of transmission techniques.

As discussed herein, various systems and components are described as “obtaining” data for the determination and detection, as embodied by the disclosure. It is understood that the corresponding data can be obtained using any solution. For example, the corresponding system/component can generate and/or be used to generate the data, retrieve the data from one or more data stores (e.g., a database), receive the data from another system/component, and/or the like. When the data is not generated by the particular system/component, it is understood that another system/component can be implemented apart from the system/component shown, which generates the data and provides it to the system/component and/or stores the data for access by the system/component.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise. “Approximately” as applied to a particular value of a range applies to both end values, and unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A method for determining mass differential in a hot gas path component of a gas turbine, the method comprising:
monitoring operational conditions of the gas turbine;
determining whether changes in a gas turbine wheelspace temperature has occurred;
determining whether a wheelspace temperature has changed by comparing the wheelspace temperature to at least one of a compressor inlet temperature and a compressor discharge temperature indicates a change in temperature;
in response to determining the wheelspace temperature indicates a change in temperature has occurred:
determining whether at least one of the following exists:
a gas turbine exhaust temperature indicates a simultaneous change with the temperature change between wheelspace temperature compared to the at least one of the compressor inlet temperature and the compressor discharge temperature, and
a gas turbine vibrational change;
in response to at least one of the simultaneous change and the vibrational change existing, indicating a mass deviation in the hot gas path component of the gas turbine.

2. The method according to claim 1, further including: monitoring operational conditions of the gas turbine, and determining whether information is available from the monitoring for determining:
a gas turbine wheelspace temperature change has occurred;
the wheelspace temperature indicates a change in temperature has occurred, and
at least one of the gas turbine exhaust temperature indicates a simultaneous change with the temperature change between wheelspace temperature compared to the at least one of compressor inlet temperature and compressor discharge temperature; and a gas turbine vibrational change.

3. The method according to claim 1, wherein the determining whether at least one of gas turbine exhaust temperatures indicate a simultaneous change with the temperature change between wheelspace temperature compared to the at least one of compressor inlet temperature and compressor discharge temperature; and a gas turbine vibrational change includes determining whether at least one of the gas turbine exhaust temperature indicates a simultaneous change with the temperature change between wheelspace temperature compared to the at least one of compressor inlet temperature and compressor discharge temperature.

4. The method according to claim 1, wherein the indicating the mass deviation in the hot gas path component of the gas turbine includes indicating a mass decrease differential in the hot gas path component.

5. The method according to claim 4, wherein the indicating the mass deviation in the hot gas path component of the gas turbine includes indicating a mass increase differential in the hot gas path component.

6. The method according to claim 1, wherein the determining whether at least one of gas turbine exhaust temperatures indicate a simultaneous change with the temperature change between wheelspace temperature compared to the at least one of compressor inlet temperature and compressor discharge temperature; and a gas turbine vibrational change includes determining whether at least one of gas turbine exhaust temperature indicates a simultaneous change with the temperature change between wheelspace temperature compared to the at least one of compressor inlet temperature and compressor discharge temperature includes a gas turbine vibrational change.

7. The method according to claim 6, wherein the indicating the mass deviation in the hot gas path component of the gas turbine includes indicating a mass decrease differential in the hot gas path component.

8. The method according to claim 6, wherein the indicating the mass deviation in the hot gas path component of the gas turbine includes indicating a mass increase differential in the hot gas path component.

9. The method according to claim 1, wherein in response to a change in gas turbine wheelspace temperatures having not occurred, continue monitoring the operational conditions of the gas turbine.

10. The method according to claim 1, wherein in response to the wheelspace temperature to at least one of compressor inlet temperature and compressor discharge temperature does not indicate a change in temperature, continue the monitoring of the operational conditions of the gas turbine.

11. The method according to claim 1, wherein in response to determining whether either gas turbine exhaust temperatures does not indicate a change or there are no vibrational changes, continue monitoring the gas turbine.

12. The method according to claim 1, wherein the method is performed in real-time.

13. A gas turbine control for a gas turbine, the control monitoring and determining mass differentials in a hot gas path component of a gas turbine, the control comprising:
at least one sensor monitoring gas turbine operational conditions, the at least one sensor monitoring one or more of shaft speed, gas turbine load, wheelspace temperature, vibration, gas turbine exhaust temperature, compressor inlet temperature, and compressor discharge temperature; and
a non-transitory computer-readable medium comprising computer-executable instructions for operating a gas turbine, the instructions including instruction for:
monitoring parameters and operational conditions of the gas turbine;
determining whether changes in gas turbine wheelspace temperatures have occurred;
determining whether wheelspace temperature indicates a change in temperature;
determining whether wheelspace temperature indicates a change in temperature has occurred; then
in response to determining the wheelspace temperature indicates a change in temperature, determining whether at least one of the following exists:
gas turbine exhaust temperature indicates a simultaneous change with the temperature change between wheelspace temperature compared to the at least one of compressor inlet temperature and compressor discharge temperature; and
a gas turbine vibrational change;
in response to at least one of the simultaneous change and the vibrational change existing, indicating a mass deviation in the hot gas path component of the gas turbine.

14. The gas turbine control according to claim 13, wherein whether at least one of gas turbine exhaust temperatures indicates a simultaneous change with the temperature change between wheelspace temperature compared to the at least one of compressor inlet temperature and compressor discharge temperature; and a gas turbine vibrational change includes determining whether at least one of gas turbine exhaust temperatures indicate a simultaneous change with the temperature change between wheelspace temperature compared to the at least one of compressor inlet temperature and compressor discharge temperature.

15. A gas turbine control according to claim 14, wherein indicating a mass deviation in the hot gas path component of the gas turbine includes indicating a mass decrease differential in hot gas path components.

16. A gas turbine control according to claim 14, wherein indicating a mass deviation in the hot gas path component of the gas turbine includes indicating a mass increase differential in hot gas path components.

17. A gas turbine control according to claim 14, wherein determining whether at least one of gas turbine exhaust temperatures indicate a simultaneous change with the temperature change between wheelspace temperature compared to the at least one of compressor inlet temperature and compressor discharge temperature; and a gas turbine vibrational change includes determining whether at least one of gas turbine exhaust temperatures indicate a simultaneous change with the temperature change between wheelspace temperature compared to the at least one of compressor inlet temperature and compressor discharge temperature includes a gas turbine vibrational change.

18. A gas turbine control according to claim 17, wherein indicating a mass deviation in the hot gas path component of the gas turbine includes indicating a mass decrease differential in hot gas path components.

19. A gas turbine control according to claim 17, wherein indicating a mass deviation in the hot gas path component of the gas turbine includes indicating a mass increase differential in hot gas path components.

20. A gas turbine control according to claim 13, wherein whether at least one of:
changes in gas turbine wheelspace temperatures have not occurred;
wheelspace temperature does not indicate a change in temperature; and
neither gas turbine exhaust temperatures does not indicate a change or there are no vibrational changes, continue monitoring the gas turbine.
